(19) United States
(12) Patent Application Publication
(10) Pub. No.: US 2017/0161317 A1
(43) Pub. Date: Jun. 8, 2017

(54) PHYSICAL TAPE DATABASE UPGRADE TOOL

(71) Applicant: Bank of America Corporation, Charloite, NC (US)

(72) Inventors: Stacy D. Glover, High Point, NC (US); Jerome M. Zott, Glastonbury, CT (US)

(21) Appl. No.: 14/961,580

(22) Filed: Dec. 7, 2015

(51) Int. Cl. G06F 17/30; G06F 11/14; G06F 9/445

(52) U.S. Cl. CPC G06F 17/30377; G06F 17/30309; G06F 8/65; G06F 11/1464; G06F 2201/80

(57) ABSTRACT

A data transformation apparatus includes a tape drive and a processor. The tape drive extracts a database from a physical tape. The processor determines a source version of the database and a final version of a database server. The processor further determines that the database server is incompatible with the extracted database and that the database cannot be upgraded directly from the source version to the final version and determines that the database should be upgraded from the source version to an intermediate version. The processor upgrades the database to the intermediate version to produce a second database. The processor also determines that the second database can be upgraded directly from the intermediate version to the final version and in response to that determination, upgrades the second database to the final version to produce a third database. The processor then loads the third database onto the database server.

### TECHNICAL FIELD

This disclosure relates generally to a system for upgrading a physical tape database.

### BACKGROUND

Databases can be stored on various storage media. For example, databases can be stored on physical tapes or on physical drives. Older storage media may be incompatible with newer database technologies. As a result, databases stored on older storage media may become inaccessible. Furthermore, older databases may be stored on tapes that take up space.

### SUMMARY OF THE DISCLOSURE

According to one embodiment, a data transformation apparatus includes a tape drive and a processor. The tape drive extracts a database from a physical tape. The processor determines a source version of the database extracted from the physical tape and determines a final version of a database server. The processor further determines, based on the source version and the final version, that the database server is incompatible with the extracted database and that the database cannot be upgraded directly from the source version to the final version and in response to that determination, determines that the database should be upgraded from the source version to an intermediate version, the intermediate version between the source version and the final version. In response to that determination, the processor upgrades the database to the intermediate version to produce a second database of the intermediate version. The processor also determines, based on the intermediate and final versions, that the second database can be upgraded directly from the intermediate version to the final version and in response to that determination, upgrades the second database to the final version to produce a third database of the final version. The processor then loads the third database onto the database server.

According to another embodiment, a method includes extracting a database from a physical tape and determining a source version of the database extracted from the physical tape. The method also includes determining a final version of a database server and determining, based on the source version and the final version, that the database server is incompatible with the extracted database and that the database cannot be upgraded directly from the source version to the final version. The method includes determining that the database should be upgraded from the source version to an intermediate version, the intermediate version between the source version and the final version in response to the determination that the database server is incompatible with the extracted database and that the database cannot be upgraded directly from the source version to the final version. The method also includes upgrading the database to the intermediate version to produce a second database of the intermediate version in response to the determination that the database should be upgraded from the source version to the intermediate version. The method further includes determining, based on the intermediate and final versions, that the second database can be upgraded directly from the intermediate version to the final version and in response to that determination, upgrading the second database to the final version to produce a third database of the final version. The method also includes loading the third database onto the database server.

According to another embodiment, one or more computer-readable non-transitory storage media embodies software that is operable when executed to extract a database from a physical tape, determine a source version of the database extracted from the physical tape, and determine a final version of a database server. The software is further operable when executed to determine, based on the source version and the final version, that the database server is incompatible with the extracted database and that the database cannot be upgraded directly from the source version to the final version and in response to that determination, determine that the database should be upgraded from the source version to an intermediate version, the intermediate version between the source version and the final version. The software is also operable when executed to upgrade the database to the intermediate version to produce a second database of the intermediate version in response to the determination that the database should be upgraded from the source version to the intermediate version. The software is further operable when executed to determine, based on the intermediate and final versions, that the second database can be upgraded directly from the intermediate version to the final version and in response to that determination, upgrade the second database to the final version to produce a third database of the final version. The software is also operable when executed to load the third database onto the database server.

Certain embodiments may provide one or more technical advantages. For example, an embodiment may allow access to databases stored on physical tape drives by incrementally upgrading the databases stored on those physical tape drives. As another example, an embodiment may reduce the physical space used to store physical tape drives by converting the databased stored on those physical tape drives to be compatible with digital storage media. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system for upgrading physical tape databases;

FIG. 2 illustrates the data transformation apparatus of FIG. 1 upgrading physical tape databases; and

FIG. 3 is a flowchart illustrating a method for upgrading physical tape databases using the system of FIG. 1.

### DETAILED DESCRIPTION

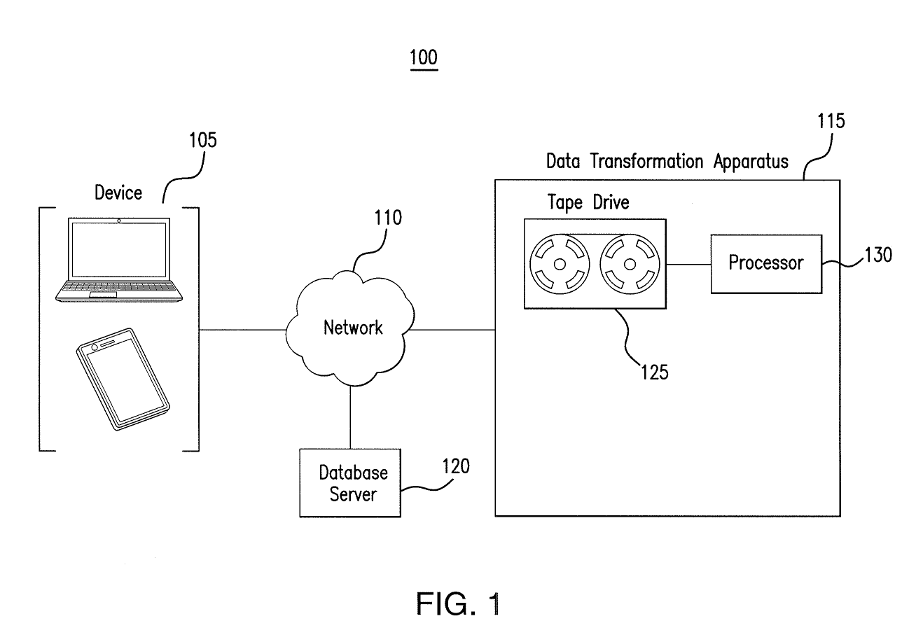

Embodiments of the present disclosure and its advantages are best understood by referring to FIGS. 1 through 3 of the drawings, like numerals being used for like and corresponding parts of the various drawings.

Databases can be stored on various storage media. For example, databases can be stored on a hard drive and/or a disk drive. As another example, databases can be stored on magnetic tape drives. The tapes may be in the form of cartridges, cassettes, and/or spools. Typically databases stored on tape drives are older than databases stored on other media. As database technology progresses, however, newer database servers may be incompatible with older databases, especially older databases stored on tape drives. As a result, older databases and databases stored on tape drives may become inaccessible as database servers progress. In certain instances, the databases stored on the tapes may not be directly upgraded to be compatible with existing database servers. For example, some database servers may only upgrade databases that are of a version that is close to the version of the database server. If the database stored on tapes are very old, then the database server may not be able to directly upgrade the database stored on the tapes.

Another issue presented by tape storage is the physical space needed to store the tapes. Many institutions may have entire rooms and/or warehouses dedicated to the storage of physical tapes. Storing tapes in this manner sometimes results in tapes being lost and/or damaged.

This disclosure contemplates a system that upgrades older databases to be compatible with newer database servers. In so doing, older databases stored on tapes may become accessible again. Moreover, the number of magnetic tapes stored in rooms and warehouse may be reduced as the databases stored on those tapes are converted to other storage media.

The system may incrementally upgrade the databases stored on the tapes until the version of the databases is compatible with the database server. For example, if the database server is version ten and the database on the tape is version zero, the system may upgrade the database on the tape from version zero to version two, to version four, and so on until the database is version ten. The system then loads the database onto the database server. In this manner, the database becomes accessible and the physical tape that stored the original database may be discarded.

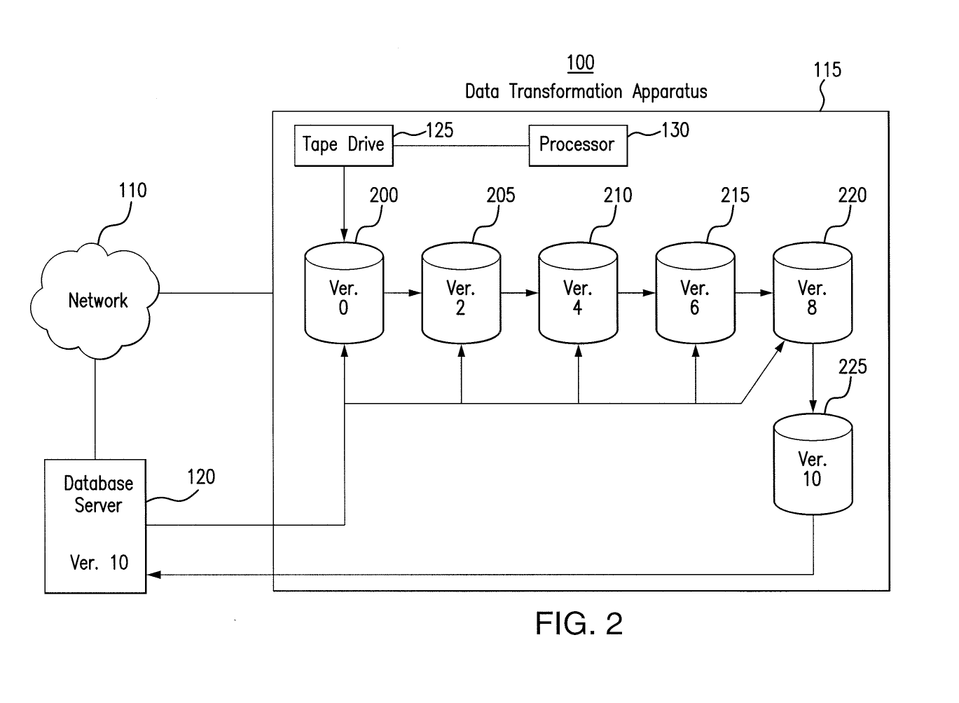

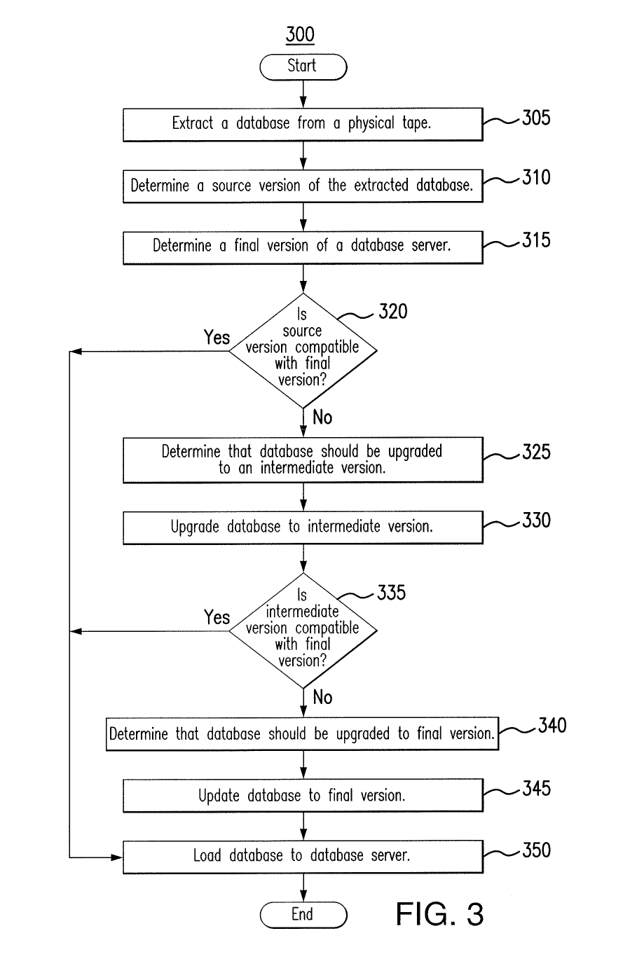

The system will be described in more detail using FIGS. 1 through 3. FIG. 1 describes the system generally. FIGS. 2 and 3 describe the system in more detail.

FIG. 1 illustrates a system 100 for upgrading physical tape databases. As illustrated, FIG. 1 includes a device 105, a network 110, a data transformation apparatus 115, and a database server 120. Generally, data transformation apparatus 115 upgrades databases stored on physical tapes so that the databases are compatible with database server 120. In particular embodiments, by using system 100 databases stored on physical tapes are upgraded and become accessible through database server 120. In some embodiments, the physical space needed to store database tapes is reduced by using system 100.

Device 105 may be used to access data transformation apparatus 115 or database server 120. For example, device 105 can issue commands to upgrade databases to data transformation apparatus 115. As another example, device 105 can issue queries against databases loaded onto database server 120. This disclosure contemplates device 105 being any appropriate device that can communicate over network 110. For example, device 105 may be a computer, a laptop, a wireless or cellular telephone, an electronic notebook, a personal digital assistant, a tablet, a server, a mainframe, or any other device capable of receiving, processing, storing, and/or communicating information with other components of system 100. Device 105 may also include a user interface, such as a display, a microphone, keypad, or other appropriate terminal equipment usable by a user. In some embodiments, an application executed by device 105 may perform the functions described herein.

Network 110 facilitates communication between and amongst the various components of system 100. This disclosure contemplates network 110 being any suitable network operable to facilitate communication between the components of system 100. Network 110 may include any interconnecting system capable of transmitting audio, video, signals, data, messages, or any combination of the preceding. Network 110 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Data transformation apparatus 115 may be used to upgrade databases and to load upgraded databases to database server 120. As illustrated, data transformation apparatus 115 includes a tape drive 125 and a processor 130. This disclosure contemplates tape drive 125 and processor 130 being configured to perform any of the functions of data transformation apparatus 115 described herein.

Tape drive 125 may read information from and/or write information to physical tapes. For example, tape drive 125 may be used to read and/or extract databases from physical tapes. As another example, tape drive 125 may write databases to physical tapes. This disclosure contemplates tape drive 125 being configured to read and write information from any appropriate type of tape. For example, tape drive 125 may read and write information from and to cassettes, cartridges, and spools. Tape drive 125 may send extracted databases to processor 130. Tape drive 125 may receive information to write to physical tapes from processor 130.

Processor 130 is any electronic circuitry, including, but not limited to microprocessors, application specific integrated circuits (ASIC), application specific instruction set processor (ASIP), and/or state machines, that communicatively couples to memory and controls the operation of data transformation apparatus 115. Processor 130 may be 8-bit, 16-bit, 32-bit, 64-bit or of any other suitable architecture. Processor 130 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processor 130 may include other hardware and software that operates to control and process information. Processor 130 executes software stored on memory to perform any of the functions described herein. Processor 130 controls the operation and administration of data transformation apparatus 115 by processing information received from network 110, device(s) 105, and memory. Processor 130 may be a programmable logic device, a microcontroller, a microprocessor, any suitable processing device, or any suitable combination of the preceding. Processor 130 is not limited to a single processing device and may encompass multiple processing devices.

Databases stored on tapes may be outdated and as a result, may not be compatible with database server 120. In these instances, the databases will need to be upgraded in order to be accessible by and through database server 120. However, sometimes the databases are so outdated that it may not be possible to directly upgrade the databases to be compatible with database server 120. To resolve this issue, it may be necessary to upgrade the databases incrementally until they are compatible with database server 120.

Data transformation apparatus 115 may upgrade databases stored on physical tapes so that those databases are compatible with database server 120. In certain embodiments, a database stored on a physical tape may not be directly upgraded to be compatible with database server 120. For example, if database server 120 is a version ten and a database stored on a physical tape is a version zero it may not be possible to upgrade the database from version zero directly to version ten. In such instances, data transformation apparatus 115 may incrementally upgrade the database to versions ten. For example, data transformation apparatus 115 may upgrade a database of version zero to version two, version four, version six, and so on until version ten.

In particular embodiments, by using data transformation apparatus 115, databases are upgraded to be compatible with database server 120. As a result, the databases are loaded onto database server 120 and device 105 can access these databases on database server 120. In some embodiments, the physical tapes used to store the original databases are discarded thereby reducing the amount of space needed to store the physical tapes.

Database server 120 may store databases. Database server 120 may also allow access to stored databases to other components of system 100, such as device 105. Database server 120 may also receive requests from other components of system 100. For example, device 105 may issue queries against databases loaded onto database server 120. Database server 120 may then respond to these queries by returning certain tables of loaded databases.

Modifications, additions, or omissions may be made to system 100 without departing from the scope of the invention. For example, data transformation apparatus 115 may be a distributed device. As another example, the components of system 100 may be integrated or separated. For example, data transformation apparatus 115 may be incorporated with any of one or more devices 105. Furthermore, system 100 may include any number of devices 105. The operation of system 100 will be described in more detail using FIGS. 2 and 3.

FIG. 2 illustrates the data transformation apparatus 115 of FIG. 1 upgrading physical tape databases. In particular embodiments, by upgrading physical tape databases, data transformation apparatus 115 may allow databases to be accessible through database server 120. In certain embodiments, data transformation apparatus 115 may incrementally upgrade databases to be compatible with database server 120. Although certain elements of system 100 have not been illustrated in FIG. 2, their omission should not be construed as their removal from system 100.

Tape drive 125 may extract a database 200 from a physical tape. Database 200 is associated with a particular version. In the illustrated example of FIG. 2, database 200 has a version of zero. This disclosure contemplates database 200 being of any version.

Data transformation apparatus 115 may receive a version of database server 120 from database server 120. In the illustrated example of FIG. 2, database server 120 may let data transformation apparatus 115 know that database server 120 is of version ten. This disclosure contemplates database server 120 being of any version.

Data transformation apparatus 115 may determine, based on the version of database server 120 and the version of database 200, whether database 200 is compatible with database server 120. If database 200 is compatible with database server 120, then data transformation apparatus 115 may load database 200 to database server 120. If database 200 is not compatible with database server 120, then data transformation apparatus 115 may upgrade database 200. In the example illustrated in FIG. 2, database 200 and database server 120 are not compatible. As a result, data transformation apparatus 115 may upgrade database 200 to a version that is compatible with database server 120.

In particular embodiments, data transformation apparatus 115 determines that database 200 can be directly upgraded to be compatible with database server 120. Using the example versions of FIG. 2, data transformation apparatus 115 may determine that database 200 can be directly upgraded from version zero to version ten. In that instance, data transformation apparatus 115 may upgrade database 200 directly from version zero to version ten and then load database 200 to database server 120.

In certain embodiments, data transformation apparatus 115 may determine that database 200 is not directly upgradeable to be compatible with database server 120. In these instances, data transformation apparatus 115 may incrementally upgrade database 200 until it is compatible with database server 120. Using the illustrated example of FIG. 2, data transformation apparatus 115 may upgrade database 200 to version two to produce a second database 205. Then data transformation apparatus 115 may upgrade database 205 to version four to produce a third database 210. Afterwards, data transformation apparatus 115 may upgrade database 210 to version six to produce a fourth database 215. Then data transformation apparatus 115 may upgrade database 215 to version eight to produce a fifth database 220. Then data transformation apparatus 115 may upgrade database 220 to versions ten to produce a sixth database 225. Because database 225 is of the same version as database server 120, database 225 is compatible with database server 120. This disclosure contemplates data transformation apparatus 115 upgrading database 200 to any number of intermediate versions before upgrading to the version of database server 120.

Data transformation apparatus 115 may load database 225 to database server 120 once data transformation apparatus 115 determines that database 225 is compatible with database server 120. After database 225 is loaded onto database server 120, database server 120 may allow other components of system 100 to access database 225. For example, database server 120 may receive queries against database 225 and return information from database 225 in response to those queries.

After database 200 has been upgraded, the physical tape used to store database 200 may be discarded. In this manner physical space is no longer needed to store the physical tape.

In particular embodiments, database server 120 may be compatible with versions other than the version of database server 120. Using the illustrated example of FIG. 2, database server 120 may be compatible with databases that are version eight. In these instances, data transformation apparatus 115 may determine that database 220 is compatible with database server 120 because database 220 is version eight. In response to that determination, data transformation apparatus 115 may load database 220 to database server 120. Furthermore, data transformation apparatus 115 may forego upgrading database 220 to version ten.

In certain embodiments, data transformation apparatus 115 stores backup copies of each of database 200, database 205, database 210, database 215, database 220, and database 225. In this manner, the backup copies may be accessed and used later on with database servers 120 that are not of version ten such as, for example, database servers 120 that are a version four.

In some embodiments, data transformation apparatus 115 may determine a name and a time of creation of database 200 when it is extracted from a physical tape. Such information may be stored on the physical tape to identify database 200. By extracting this information, data transformation apparatus 115 may propagate that information to database server 120.

In particular embodiments, data transformation apparatus 115 may incrementally upgrade databases by using a second database server. The second database server may be compatible with the source version of the database and the upgraded version of the database. Using the illustrated example of FIG. 2, data transformation apparatus 115 may use a second database server to upgrade database 200 to database 205. In that example, the second database server may be compatible with both databases of version zero and databases of version two. This disclosure contemplates the second database server being any appropriate type of server. For example, the second database server may be a virtual server or a physical server.

In some embodiments, data transformation apparatus 115 may maintain a copy of database 200 in the physical tape even after database 200 has been extracted and upgraded. In this manner, the database may be preserved if the decision is made to keep the tape.

In particular embodiments, by using system 100 databases may be incrementally upgraded to be compatible with database server 120. In some embodiments, the physical space needed to store physical tapes may be reduced by converting databases stored on physical tapes to be compatible with database server 120.

FIG. 3 is a flowchart illustrating a method 300 for upgrading physical tape databases using the system 100 of FIG. 1. In particular embodiments, data transformation apparatus 115 performs method 300. By performing method 300, data transformation apparatus 115 may allow databases to be incrementally upgraded to be compatible with database servers. Furthermore, data transformation apparatus 115 may reduce the amount of physical space needed to store physical tapes.

Data transformation apparatus 115 may begin by extracting a database from a physical tape in step 305. Then at step 310, data transformation apparatus 115 may determine a source version of the extracted database. In step 315, data transformation apparatus 115 may determine a final version of a database server. Then in step 320, data transformation apparatus 115 may determine whether the source version of the extracted database is compatible with the final version of the database server. If the source version is compatible with the final version then data transformation apparatus 115 may conclude by loading the database to the database server in step 350.

If the source version is not compatible with the final version, data transformation apparatus 115 may determine that the database should be upgraded to an intermediate version 325. Data transformation apparatus 115 may make this determination after determining that the database is not directly upgradeable to a version compatible with the database server. In step 330, data transformation apparatus 115 may upgrade the database to the intermediate version. Then in step 335, data transformation apparatus 115 may determine whether the intermediate version of the database is compatible with the final version of the database server. If the intermediate version is compatible with the final version, data transformation apparatus 115 may conclude by loading the database to the database server in step 350.

If data transformation apparatus 115 determines that the intermediate version is not compatible with the final version, then data transformation apparatus 115 may determine that the database should be upgraded to the final version in step 340. Then in step 345, data transformation apparatus 115 may upgrade the database to the final version. Then data transformation apparatus 115 may conclude by loading the database to the database server in step 350.

Modifications, additions, or omissions may be made to method 300 depicted in FIG. 3. Method 300 may include more, fewer, or other steps. For example, steps may be performed in parallel or in any suitable order. While discussed as data transformation apparatus 115 performing the steps, any suitable component of system 100, such as device 105 for example, may perform one or more steps of the method.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A data transformation apparatus comprising:
a tape drive configured to extract a database from a physical tape; and
a processor communicatively coupled to the tape drive, the processor configured to:
determine a source version of the database extracted from the physical tape;
determine a final version of a database server;
determine, based on the source version and the final version, that the database server is incompatible with the extracted database and that the database cannot be upgraded directly from the source version to the final version;
in response to the determination that the database server is incompatible with the extracted database and that the database cannot be upgraded directly from the source version to the final version, determine that the database should be upgraded from the source version to an intermediate version, the intermediate version between the source version and the final version;
in response to the determination that the database should be upgraded from the source version to the intermediate version, upgrade the database to the intermediate version to produce a second database of the intermediate version;
determine, based on the intermediate and final versions, that the second database can be upgraded directly from the intermediate version to the final version;
in response to the determination that the second database can be upgraded directly from the intermediate version to the final version, upgrade the second database to the final version to produce a third database of the final version; and
load the third database onto the database server.

2. The data transformation apparatus of claim 1, wherein the processor is further configured to:
determine that the database server is compatible with databases of the intermediate version; and
in response to the determination that the database server is compatible with databases of the intermediate version, load the second database onto the database server.

3. The data transformation apparatus of claim 1, wherein the processor is further configured to store a backup copy of each of the database, the second database, and the third database.

4. The data transformation apparatus of claim 1, wherein the processor is further configured to:
determine that the second database cannot be directly upgraded to the final version;
in response to the determination that the second database cannot be directly upgraded to the final version, upgrade the second database to a second intermediate version to produce a fourth database, the second intermediate version between the intermediate version and the final version; and
upgrade the fourth database to the final version.

5. The data transformation apparatus of claim 1, wherein the database server is incompatible with databases of the source version.

6. The data transformation apparatus of claim 1, wherein upgrading the database from the source version to the intermediate version comprises:
loading the database onto a second database server compatible with both the source version and the intermediate version; and
upgrading, using the second database server, the database from the source version to the intermediate version.

7. The data transformation apparatus of claim 1, wherein the physical tape maintains a copy of the database after the database is extracted from the physical tape.

8. A method comprising:
extracting a database from a physical tape;
determining a source version of the database extracted from the physical tape;
determining a final version of a database server;
determining, based on the source version and the final version, that the database server is incompatible with the extracted database and that the database cannot be upgraded directly from the source version to the final version;
in response to the determination that the database server is incompatible with the extracted database and that the database cannot be upgraded directly from the source version to the final version, determining that the database should be upgraded from the source version to an intermediate version, the intermediate version between the source version and the final version;
in response to the determination that the database should be upgraded from the source version to the intermediate version, upgrading the database to the intermediate version to produce a second database of the intermediate version;
determining, based on the intermediate and final versions, that the second database can be upgraded directly from the intermediate version to the final version;
in response to the determination that the second database can be upgraded directly from the intermediate version to the final version, upgrading the second database to the final version to produce a third database of the final version; and
loading the third database onto the database server.

9. The method of claim 8, further comprising:
determining that the database server is compatible with databases of the intermediate version; and
in response to the determination that the database server is compatible with databases of the intermediate version, loading the second database onto the database server.

10. The method of claim 8, further comprising storing a backup copy of each of the database, the second database, and the third database.

11. The method of claim 8, further comprising determining a name and a time of creation of the database.

12. The method of claim 8, wherein the database server is incompatible with databases of the source version.

13. The method of claim 8, wherein upgrading the database from the source version to the intermediate version comprises:
loading the database onto a second database server compatible with both the source version and the intermediate version; and
upgrading, using the second database server, the database from the source version to the intermediate version.

14. The method of claim 8, wherein the physical tape maintains a copy of the database after the database is extracted from the physical tape.

15. One or more computer-readable non-transitory storage media embodying software that is operable when executed to:
extract a database from a physical tape;
determine a source version of the database extracted from the physical tape;
determine a final version of a database server;
determine, based on the source version and the final version, that the database server is incompatible with the extracted database and that the database cannot be upgraded directly from the source version to the final version;
in response to the determination that the database server is incompatible with the extracted database and that the database cannot be upgraded directly from the source version to the final version, determine that the database should be upgraded from the source version to an intermediate version, the intermediate version between the source version and the final version;
in response to the determination that the database should be upgraded from the source version to the intermediate version, upgrade the database to the intermediate version to produce a second database of the intermediate version;
determine, based on the intermediate and final versions, that the second database can be upgraded directly from the intermediate version to the final version;
in response to the determination that the second database can be upgraded directly from the intermediate version to the final version, upgrade the second database to the final version to produce a third database of the final version; and
load the third database onto the database server.

16. The media of claim 15, embodying software that is further operable when executed to:
determine that the database server is compatible with databases of the intermediate version; and
in response to the determination that the database server is compatible with databases of the intermediate version, load the second database onto the database server.

17. The media of claim 15, embodying software that is further operable when executed to store a backup copy of each of the database, the second database, and the third database.

18. The media of claim 15, embodying software that is further operable when executed to determine a name and a time of creation of the database.

19. The media of claim 15, wherein the database server is incompatible with databases of the source version.

20. The media of claim 15, wherein upgrading the database from the source version to the intermediate version comprises:
loading the database onto a second database server compatible with both the source version and the intermediate version; and
upgrading, using the second database server, the database from the source version to the intermediate version.

21. The media of claim 15, wherein the physical tape maintains a copy of the database after the database is extracted from the physical tape.
